(19) United States
(12) Patent Application Publication
(10) Pub. No.: US 2023/0247420 A1
(43) Pub. Date: Aug. 3, 2023

(54) GRANULAR USER CONSENT AND ITS ENFORCEMENT

(71) Applicant: QUALCOMM Incorporated, San Diego, CA (US)

(72) Inventors: Rajeev KUMAR, San Diego, CA (US); Olufunmilola Omolade AWONIYI-OTERI, San Diego, CA (US); Gavin Bernard HORN, La Jolla, CA (US); Aziz GHOLMIEH, Del Mar, CA (US); Soo Bum LEE, San Diego, CA (US); Marwen ZORGUI, San Diego, CA (US); Hongil KIM, San Diego, CA (US)

(21) Appl. No.: 18/161,507

(22) Filed: Jan. 30, 2023

Related U.S. Application Data
(60) Provisional application No. 63/267,387, filed on Jan. 31, 2022.

(51) Int. Cl. H04W 12/02; H04W 12/08

(52) U.S. Cl. CPC H04W 12/02; H04W 12/08

(57) ABSTRACT

A first network node may transmit, to a second network node, first information associated with granular user consent control. The first information may be further associated with a data processing task and a UE. The second network node may receive, from the first network node or the UE, second information associated with the granular user consent control. The second information may be further associated with the data processing task and the UE. The second network node may identify a user consent result associated with the data processing task and a user of the UE based on the granular user consent control. The user consent result may be further based on the first information or the second information. The second network node may transmit, to the first network node, the user consent result. Thereafter, the first network node may handle the data processing task based on the user consent result.

### CROSS REFERENCE TO RELATED APPLICATION(S)

This application claims the benefit of and priority to U.S. Provisional Application Ser. No. 63/267,387, entitled “GRANULAR USER CONSENT AND ITS ENFORCEMENT” and filed on Jan. 31, 2022, which is expressly incorporated by reference herein in its entirety.

### TECHNICAL FIELD

The present disclosure relates generally to communication systems, and more particularly, to user consent control and enforcement in a communication system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies. There further exists a need to improve the user's control over data sharing with the network.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a first network node. The apparatus may transmit, to a second network node, first information associated with granular user consent control. The first information may be further associated with a data processing task and a user equipment (UE). The apparatus may receive, from the second network node, a user consent result associated with the data processing task and a user of the UE based on the granular user consent control. The apparatus may handle the data processing task based on the user consent result.

In an aspect of the disclosure, a method, a computer-readable medium, and an apparatus are provided. The apparatus may be a second network node. The apparatus may receive, from a first network node, first information associated with granular user consent control. The first information may be further associated with a data processing task and a UE. The apparatus may receive, from the first network node or the UE, second information associated with the granular user consent control. The second information may be further associated with the data processing task and the UE. The apparatus may identify a user consent result associated with the data processing task and a user of the UE based on the granular user consent control. The user consent result may be further based on the first information or the second information. The apparatus may transmit, to the first network node or the UE, the user consent result.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network, in accordance with various aspects of the present disclosure.

FIG. 4 is a diagram illustrating example user consent information stored at a unified data management (UDM), in accordance with various aspects of the present disclosure.

FIG. 5 is a diagram illustrating a flowchart of an example method of user consent handling at a subscribing entity according to one or more aspects.

FIG. 6 is a diagram illustrating a flowchart of an example method of user consent handling at a UDM according to one or more aspects.

FIG. 7 is a diagram illustrating a communication flow of an example method for enforcing an updated user consent result according to one or more aspects.

FIG. 8 is a diagram illustrating a communication flow of an example method for enforcing an updated user consent result according to one or more aspects.

FIG. 9 is a diagram illustrating a communication flow of an example method for enforcing an updated user consent result according to one or more aspects.

FIG. 10 is a diagram illustrating a communication flow of an example method of wireless communication, in accordance with various aspects of the present disclosure.

FIG. 11 is a flowchart of a method of wireless communication, in accordance with various aspects of the present disclosure.

FIG. 12 is a flowchart of a method of wireless communication, in accordance with various aspects of the present disclosure.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a diagram illustrating an example of a hardware implementation for an example apparatus, in accordance with various aspects of the present disclosure.

FIG. 16 is a diagram illustrating an example of a hardware implementation for an example apparatus, in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

As data processing tasks such as data collection and other use cases are performed with increasing frequency, techniques for managing how user-related data is collected and processed by the wireless communication network may be desirable. In particular, it may be suitable or desirable to enforce restrictions on data collection and/or processing based on the user consent or the absence thereof. In one or more examples, a first network node (e.g., a subscribing entity/a data collection requesting entity) may transmit, to a second network node (e.g., a UDM), and the second network node may receive, from the first network node, first information associated with granular user consent control (i.e., user consent control at various granularities, for different users/services/use cases, etc.). The first information may be further associated with a data processing task and a UE. The second network node may receive, from the first network node or the UE, second information associated with the granular user consent control. The second information may be further associated with the data processing task and the UE. The second network node may identify a user consent result (e.g., whether the user consents to the data collection) associated with the data processing task and a user of the UE based on the granular user consent control for the user for a specific service or services. The user consent result may be further based on the first information or the second information. The second network node may transmit, to the first network node, and the first network node may receive, from the second network node, the user consent result. Thereafter, the first network node may handle the data processing task based on the user consent result. Accordingly, user consent-based restrictions on data collection or processing tasks may be implemented and enforced at fine granularities, which may afford the user more flexibility in controlling the data collection or processing tasks.

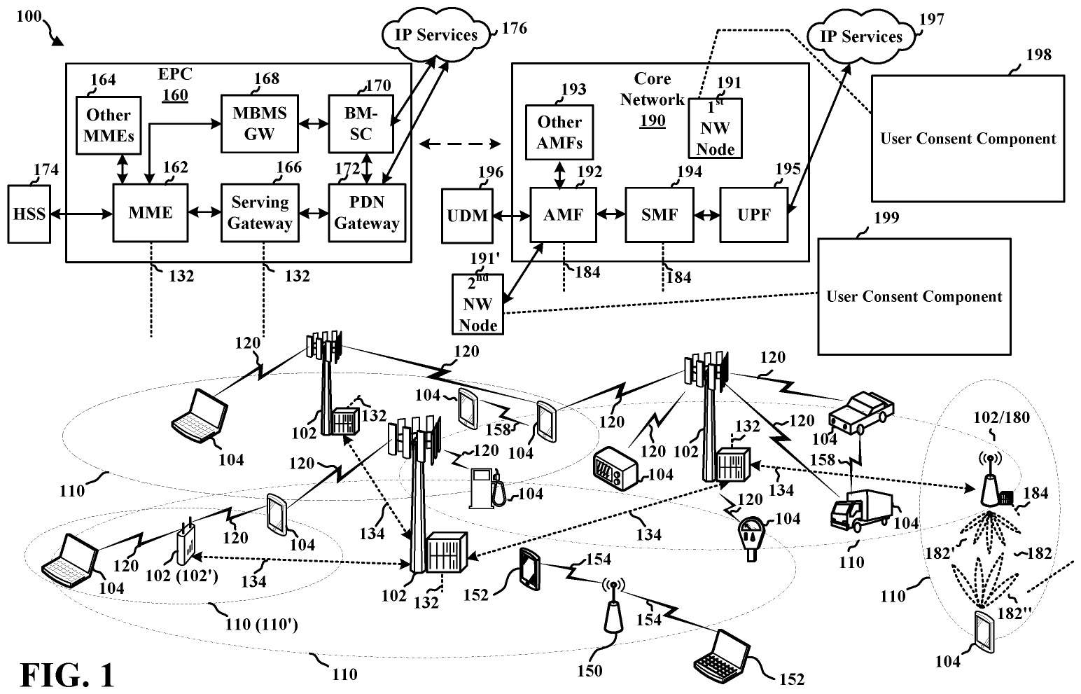

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a first network node 191 (e.g., an operations, administration, and maintenance (OAM), a RAN, or a network data analytics function (NWDAF)) may include a user consent component 198 that may be configured to transmit, to a second network node, first information associated with granular user consent control. The first information may be further associated with a data processing task and a UE. The user consent component 198 may be configured to receive, from the second network node, a user consent result associated with the data processing task and a user of the UE based on the granular user consent control. The user consent component 198 may be configured to handle the data processing task based on the user consent result. In certain aspects, a second network node 191′ (e.g., a UDM) may include a user consent component 199 that may be configured to receive, from a first network node, first information associated with granular user consent control. The first information may be further associated with a data processing task and a UE. The user consent component 199 may be configured to receive, from the first network node or the UE, second information associated with the granular user consent control. The second information may be further associated with the data processing task and the UE. The user consent component 199 may be configured to identify a user consent result associated with the data processing task and a user of the UE based on the granular user consent control. The user consent result may be further based on the first information or the second information. The user consent component 199 may be configured to transmit, to the first network node or the UE, the user consent result. In different configurations, the user consent component 198 and/or the user consent component 199 may be implemented in software, hardware, or a combination thereof. Although the following description may be focused on 5G NR, the concepts described herein may be applicable to other similar areas, such as LTE, LTE-A, CDMA, GSM, and other wireless technologies.

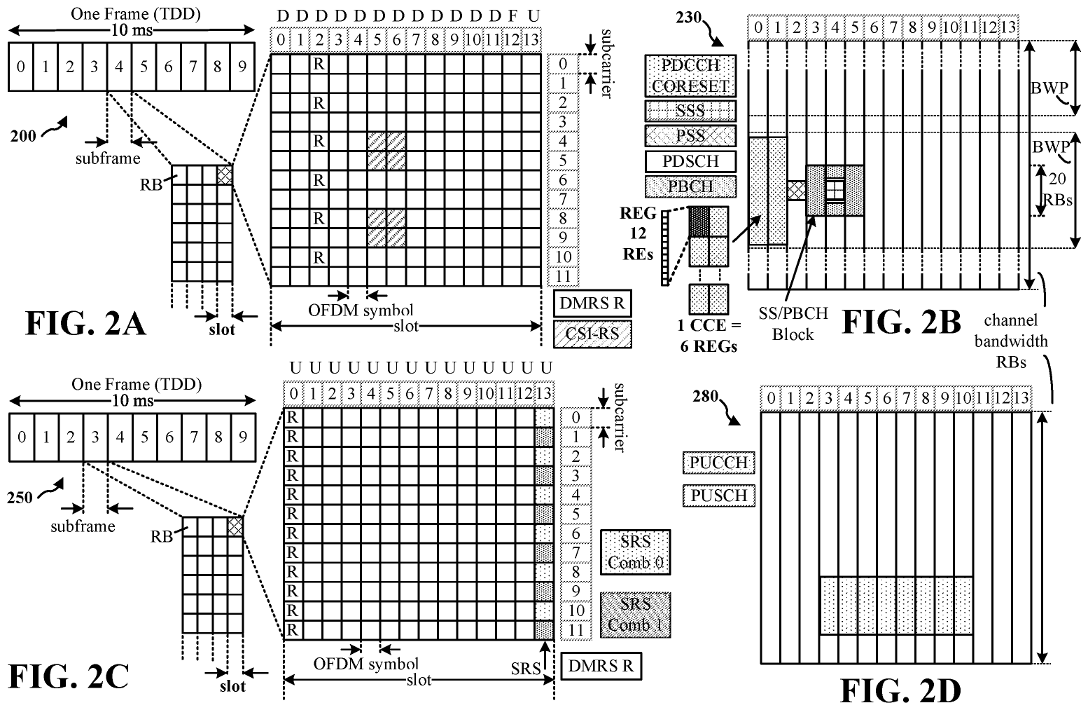

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) (see Table 1) and, effectively, the symbol length/duration, which is equal to 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

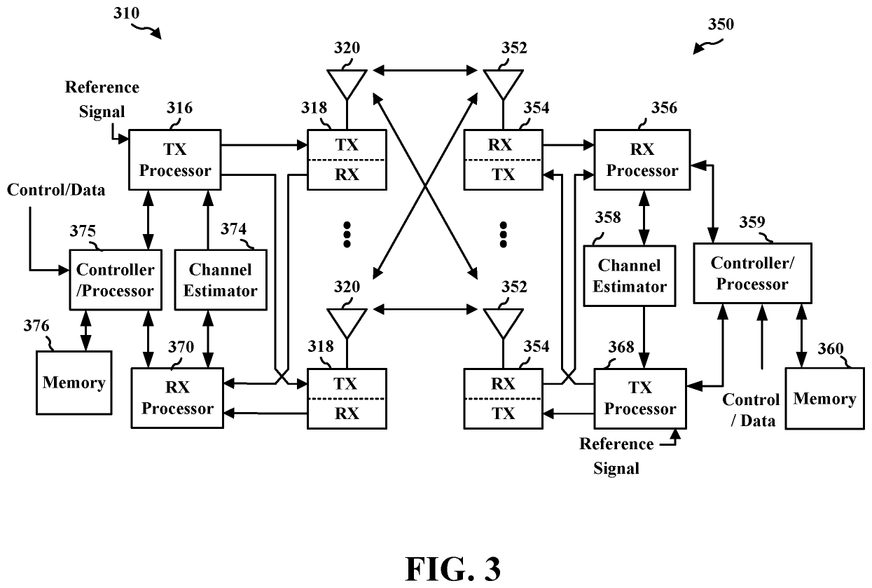

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

A network node can be implemented as an aggregated base station, as a disaggregated base station, an integrated access and backhaul (IAB) node, a relay node, a sidelink node, etc. A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (MC), or a Non-Real Time (Non-RT) RIC.

Herein data processing may refer to any operation or set of operations which is performed on personal data or on sets of personal data, whether or not by automated means, such as collection, recording, organization, structuring, storage, adaptation or alteration, retrieval, consultation, use, disclosure by transmission, dissemination or otherwise making available, alignment or combination, restriction, erasure or destruction.

As data processing tasks such as data collection and other use cases are performed with increasing frequency, techniques for managing how user-related data is collected and processed by the wireless communication network may be desirable. In particular, it may be suitable or desirable to enforce restrictions on data collection and/or processing based on the user consent or the absence thereof. In other words, data collection and/or processing may be performed where the user consent is present, and may not be performed where the user consent is not present. Use cases where such restrictions may be enforced may include, for example, data collection associated with the minimization of drive test (MDT) or the self-organizing networks (SON) framework, data collection associated with quality of experience (QoE), artificial intelligence (AI)/machine learning (ML) training, AI/ML inference, data collection for AI/ML use cases where the MDT framework is not used, or RF sensing, etc.

In one or more configurations, data collection for the MDT may be based on the user consent. In one or more configurations, collection and/or processing of a user's personal data for a specific purpose at a network data analytics function (NWDAF) may be performed based on the user consent. In one or more configurations, user consent parameters (e.g., parameters that define the user consent with respect to particular data collection or processing activities) may become effective after the user consent is provided, and may remain effective until revoked by the user. In one or more configurations, the user consent may be provided, modified, or revoked in an out-of-band fashion (e.g., at a point of sale or through customer service channels such as a web portal).

In one or more configurations, user consent parameters may be stored and maintained at a UDM. In particular, the user consent parameters may include one or more of a UE identifier (ID), a data processor ID, a purpose of data processing, or a user consent result. Among these parameters, in one or more examples, the UE ID may be a subscription permanent identifier (SUPI). Further, the data processor ID may correspond to a data processor that processes data for the UE, and may be an application function (AF) ID or a more generic ID (e.g., a “3rd party” indicator or an “all” indicator). Moreover, the purpose of data processing may be combined with a service operation name and/or additional input. Furthermore, a positive user consent result may indicate that there is user consent for the corresponding data processor to process the data according to the corresponding purpose of data processing.

In one or more configurations, the user consent for data collection and/or processing may be provided and enforced at a finer granularity than described above. In one or more configurations, new user consent may be provided and enforced on a per use case or service basis. In one or more configurations, a procedure to enforce an update to the existing user consent may be provided. In one or more configurations, a UDM may maintain the user consent information on a per service basis for a given user. In one or more configurations, the UDM may maintain the user consent information based on a fine granularity. In one or more configurations, the UDM may maintain the user consent information based on the user ID for devices shared by multiple users. In one or more configurations, the UDM may store the user consent on a per service basis. Depending on different use cases, additional parameters associated with the user consent may also be stored at the UDM.

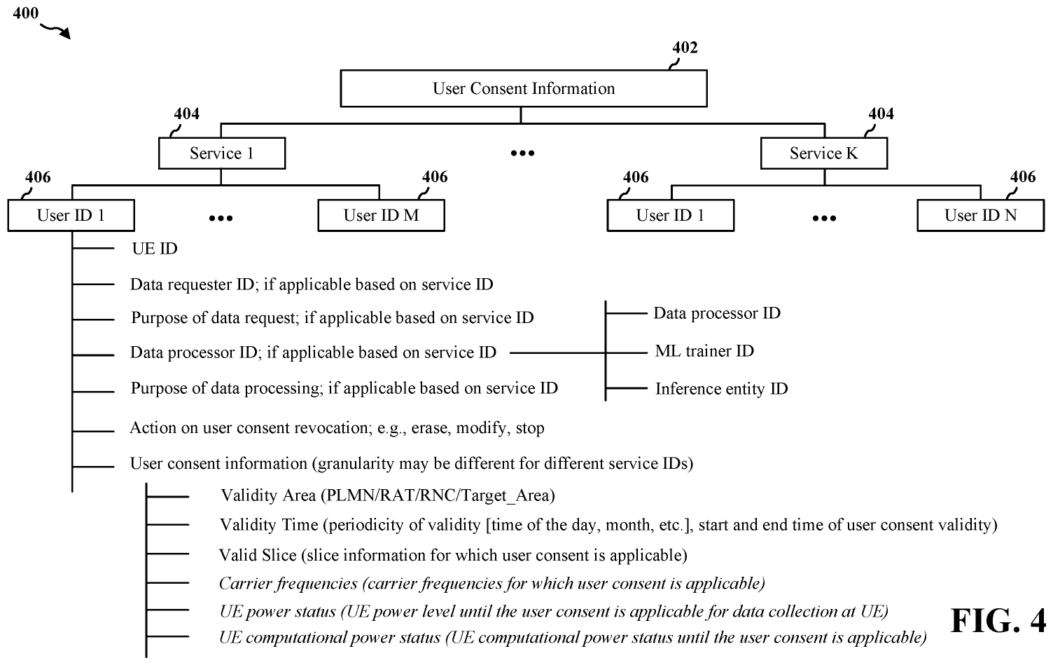

FIG. 4 is a diagram 400 illustrating example user consent information stored at a UDM according to one or more aspects. As shown in FIG. 4, the user consent information 402 may include a set of user consent parameters stored for each combination of a service 404 (which may be identified by a service ID) and a user 406 (which may be identified by a user ID). For each combination of a service 404 and a user 406, the example set of user consent parameters may include one or more of a UE ID, a data requester ID (if applicable to the service), a purpose of data request (if applicable to the service), a data processor ID (e.g., a data processor ID, a ML trainer ID, or an inference entity ID) (if applicable to the service), a purpose of data processing, an action to take on revocation of the user consent (e.g., erase the data, modify the data collection and/or processing, or stop the data collection and/or processing), or user consent information (e.g., one or more validity conditions associated with the user consent where the user consent is not valid/effective if the validity conditions are not met). In one or more configurations, the validity conditions may be associated with different granularities for different services. In particular, the validity conditions may correspond to, for example, a validity area (e.g., a public land mobile network (PLMN) coverage area, a RAT coverage area, a radio network controller (RNC) coverage area, a target area (e.g., a geographical area or a geopolitical name of an area: The PLMN may translate and define the target area as the identities of one or more radio cells or tracking areas), etc.), a validity time (e.g., periodicity of the validity time, start and end times of the validity time, etc.), a validity slice (e.g., a slice for which the user consent is effective), one or more carrier frequencies (e.g., carrier frequencies for which the user consent is effective), a UE power status (e.g., a threshold remaining UE power level above which the user consent is effective), or a UE computational power status (e.g., a threshold available UE computational power level above which the user consent is effective), etc. Accordingly, in one or more configurations, based on conditions or factors associated with an attempted data collection or processing task, a user consent result that may be either positive (i.e., the task is allowed based on the user consent) or negative (i.e., the task is not allowed based on the absence of user consent) may be identified based on the stored user consent parameters.

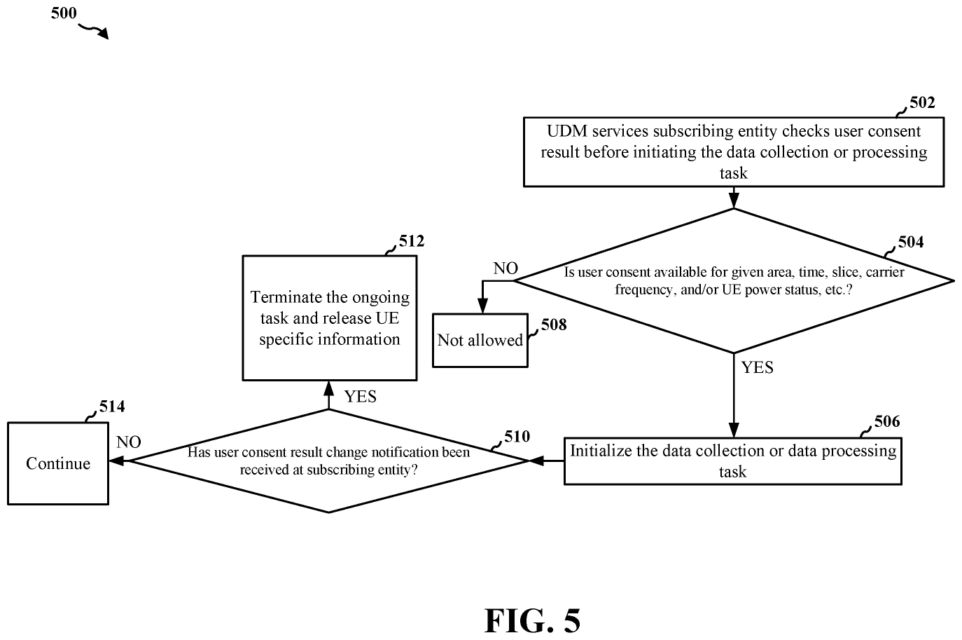

FIG. 5 is a diagram illustrating a flowchart 500 of a method of user consent handling at a subscribing entity according to one or more aspects. In some examples, a subscribing entity may refer to an entity that may initiate a data collection or processing task at a UE. For example, for the MDT data collection, the subscribing entity may be an OAM. For ML related data collection or processing tasks, the subscribing entity may be an OAM or a RAN. In additional examples, a subscribing entity may refer to an entity that may initiate a data collection or processing task at another network node for a specific user. For example, for federated data analytics or ML related data collection or processing tasks, the subscribing entity may be an NWDAF. In further examples, a subscribing entity may refer to an entity that may perform a data processing task related to a specific UE.

At 502, a subscribing entity may check (e.g., by querying a UDM) a user consent result associated with a data collection or processing task before attempting to initiate the data collection or processing task. The user consent result may be based on one or more of an area, a PLMN, a RAT, an RNC, a target area, a slice, a service, a carrier frequency, a time, a UE power status, available UE computational power, or a user of the UE. Accordingly, at 504, the user consent result may be returned from the UDM based on one or more of the above-described conditions or factors or similar conditions or factors. If the user consent result is positive (yes), at 506, the subscribing entity may initiate the data collection or processing task. On the other hand, if the user consent result is negative (no), at 508, the subscribing entity may not initiate the data collection or processing task because the task is not allowed based on the user consent parameters stored at the UDM.

After the data collection or processing task is initiated at 506, at 510, the subscribing entity may identify whether a user consent result change notification has been received from the UDM. If a user consent result change notification has been received (yes), and the updated user consent result is negative, at 512, the subscribing entity may terminate the data collection or processing task. Further, the subscribing entity may release user specific information. For example, if the user revokes the consent, then the subscribing entity may erase the user specific information (if instructed to do so based on the user consent result). If a user consent result change notification has not been received (no), at 514, the subscribing entity may continue with the data collection or processing task.

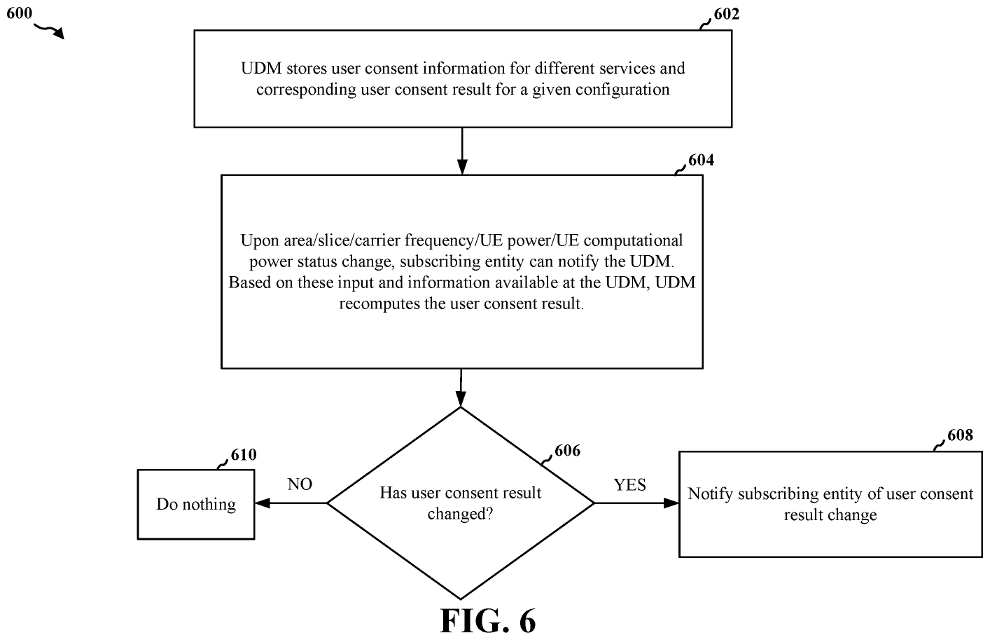

FIG. 6 is a diagram illustrating a flowchart 600 of an example method of user consent handling at a UDM according to one or more aspects. At 602, the UDM may store the user consent information for different services and the corresponding user consent result for any given configuration. At 604, the UDM may be notified by the subscribing entity if any of the conditions or factors that may affect the user consent result (e.g., an area, a slice, a carrier frequency, a UE power status, a UE computational power status, etc.) have changed since a last user consent result was provided to the subscribing entity. Based on the notification and the user consent information stored at the UDM, the UDM may recompute (re-identify) an updated user consent result. At 606, the UDM may identify whether the updated user consent result is different from the last user consent result provided to the subscribing entity. If the updated user consent result is different (yes), at 608, the UDM may notify the subscribing entity of the user consent result change, so that the subscribing entity may act accordingly. If the updated user consent result is not different from the last user consent result provided to the subscribing entity (no), at 610, the UDM may not perform any additional operations (at least not until the UDM is notified of any change in the conditions or factors that may affect the user consent result).

Therefore, the network may enforce restrictions on data collection or processing tasks based on the user consent. In one or more configurations, the operator may be the data controller. In one or more configurations, a data collection requesting entity may refer to the entity that may request the UE to collect data. In some examples, the data collection requesting entity may be identified by an AF ID, or a more generic ID (e.g., a “3rd party” indicator or an “all” indicator). In one or more configurations, a data processor may refer to an entity that may process data from the UE. In some examples, the data processor may be identified by an AF ID, or a more generic ID (e.g., a “3rd party” indicator or an “all” indicator). In one or more examples, a user may update their user consent information in an out-of-band fashion (e.g., through customer service channels such as an operator web portal).

Accordingly, a subscribing entity may be a data processor and/or a data collection requesting entity. In one or more configurations, the UDM may notify the subscribing entity about any update to the user consent result based on the various conditions or factors. Upon receiving a notification from the UDM about a change in the user consent result, the subscribing entity may modify or terminate the active (ongoing) data collection or processing task, or may reconfigure the UE to modify the data collection procedure.

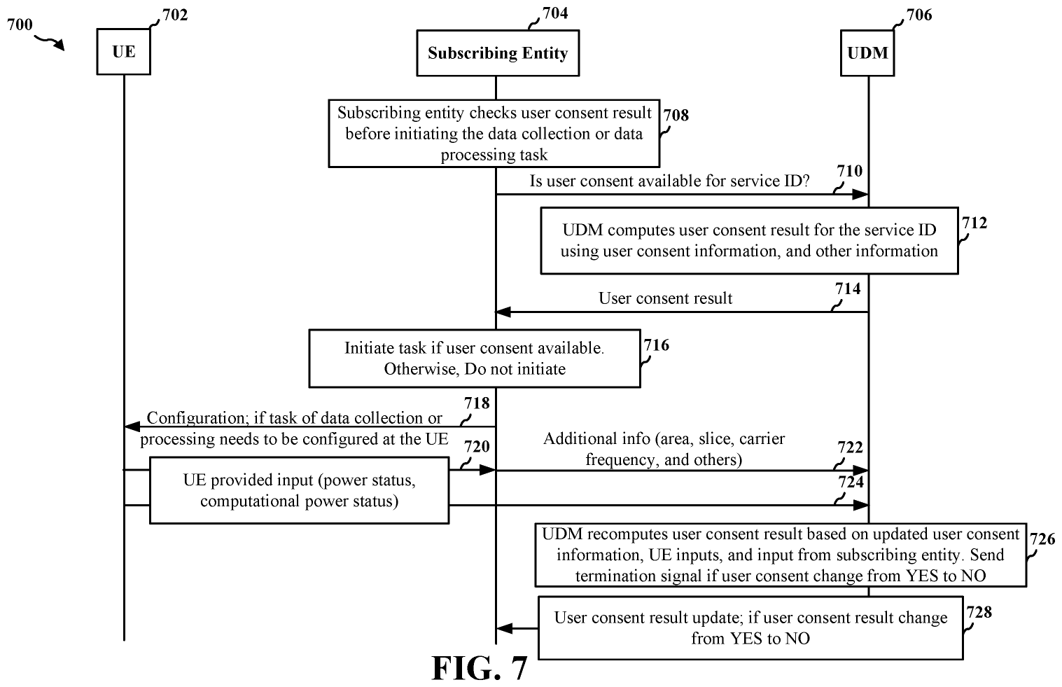

FIG. 7 is a diagram illustrating a communication flow 700 of an example method for enforcing an updated user consent result according to one or more aspects. At 708, a subscribing entity 704 may check the user consent result associated with a data collection or processing task before attempting to initiate the data collection or processing task. The data collection or processing task may correspond to a service, and may be associated with a service ID. At 710, the subscribing entity 704 may transmit, to a UDM 706, a request for a user consent result. The subscribing entity 704 may also transmit, to the UDM 706, indications of conditions or factors that may affect the user consent result.

At 712, the UDM 706 may compute (identify) a user consent result for the service ID based on the user consent information stored at the UDM 706 and other information (e.g., indications received from the subscribing entity 704 and/or the UE 702). At 714, the UDM 706 may transmit, to the subscribing entity 704, the user consent result. At 716, if the user consent result is positive, the subscribing entity 704 may initiate the data collection or processing task. On the other hand, if the user consent result is negative, the subscribing entity 704 may not initiate the data collection or processing task.

At 718, if suitable or appropriate, the subscribing entity 704 may configure the UE 702 to perform the data collection or processing task. At 720 and/or 724, the UE 702 may provide the UE-gathered inputs that may affect the user consent result (e.g., the UE power status, the available UE computational power status, etc.) to the subscribing entity 704 and/or directly to the UDM 706. If the UE-gathered inputs are provided to the subscribing entity 704 by the UE 702, the subscribing entity 704 may forward the UE-gathered inputs to the UDM 706 at 722. Further, at 722, the subscribing entity 704 may provide additional information that may affect the user consent result (e.g., an area, a slice, a carrier frequency, a time, etc.) to the UDM 706.

At 726, the UDM 706 may recompute (re-identify) an updated user consent result based on updated user consent information, updated UE-gathered inputs, and the updated input from the subscribing entity 704. If the updated user consent result is different from the user consent result 714 provided to the subscribing entity 704, the UDM 706 may notify the subscribing entity 704 of the change in the user consent result. In particular, if the user consent result has changed from being positive to being negative, the UDM 706 may transmit a termination signal to the subscribing entity 704 to prompt the subscribing entity 704 to terminate the data collection or processing task.

At 728, if the updated user consent result is different from the user consent result 714 provided to the subscribing entity 704, the UDM 706 may notify the subscribing entity 704 of the change in the user consent result, so that the subscribing entity 704 may act accordingly. In some configurations, the subscribing entity 704 may choose not to terminate the data collection or processing task even though the user consent result has changed to being negative. Instead, the subscribing entity 704 may modify the trace session associated with the data collection or processing task based on the updated user consent result.

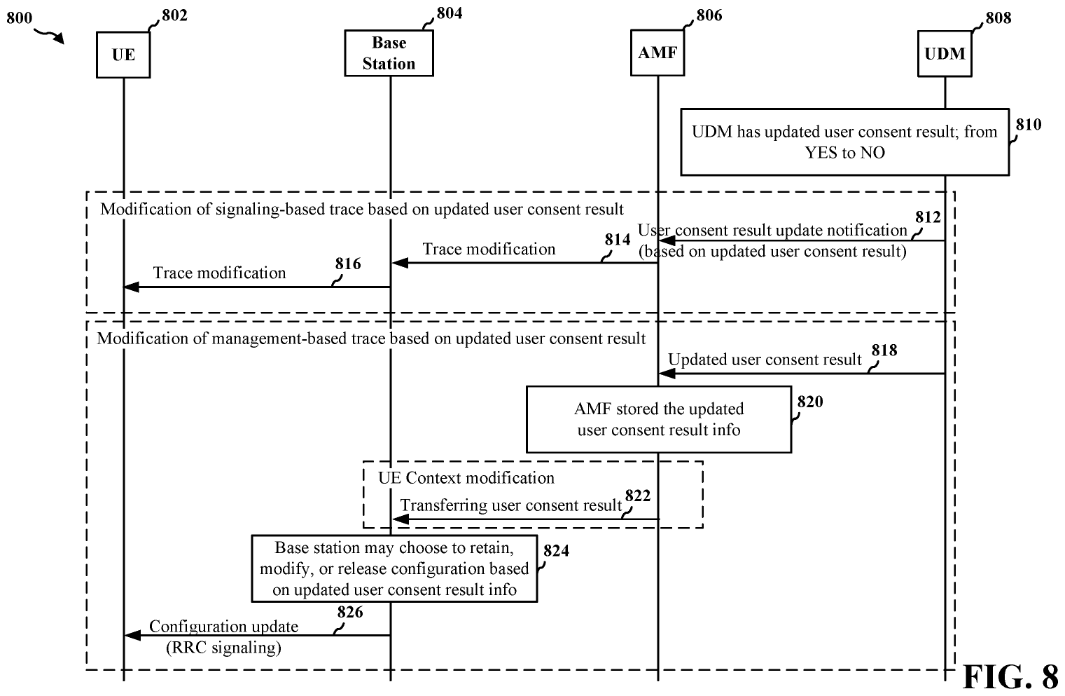

FIG. 8 is a diagram illustrating a communication flow 800 of an example method for enforcing an updated user consent result according to one or more aspects. In particular, at 810, the UDM 808 has identified that the user consent result has changed to being negative based on the latest inputs (e.g., 720, 722, 724) indicating the updated conditions or factors that may affect the user consent result.

In one or more configurations, for modification of a signaling-based trace session based on the updated user consent result, at 812, the UDM 808 may notify an AMF 806 of the update to the user consent result based on the updated user consent result. At 814, the AMF 806 may transmit, to a base station 804, a first indication of trace session modification based on the updated user consent result. At 816, the base station 804 may transmit, to the UE 802, a second indication of trace session modification based on the updated user consent result. Accordingly, the trace session may be modified at the UE 802 based on the updated user consent result.

In one or more configurations, for modification of a management-based trace session based on the updated user consent result, at 818, the UDM 808 may transmit, to the AMF 806, an indication of the updated user consent result. At 820, the AMF 806 may store information about the updated user consent result. At 822, the AMF 806 may transfer the updated user consent result to the base station 804 based on a UE context modification message. At 824, the base station 804 may choose to retain, modify, or release the configuration associated with the data collection or processing task based on the information about the updated user consent result. At 826, the base station 804 may transmit, to the UE 802, a configuration update indicative of the updated user consent result (e.g., via RRC signaling).

In one or more configurations, the UDM 808 may not know about the active (ongoing) trace session associated with the data collection or processing task. Accordingly, excessive unnecessary signaling may be involved if a trace session is not active for the user/UE. For example, when user consent is updated, then the corresponding ongoing trace session for data collection or processing may be updated as well. However, many a time there may not be any ongoing trace session associated with the user/UE for which the user consent is updated. In such a scenario, if the UDM nonetheless updates the OAM about the user consent update, the associated signaling may be considered unnecessary signaling. In one or more other configurations, based on the updated user consent result, the UDM may send the updated user consent result to the UE for potential termination or modification of the data collection or processing task at the UE.

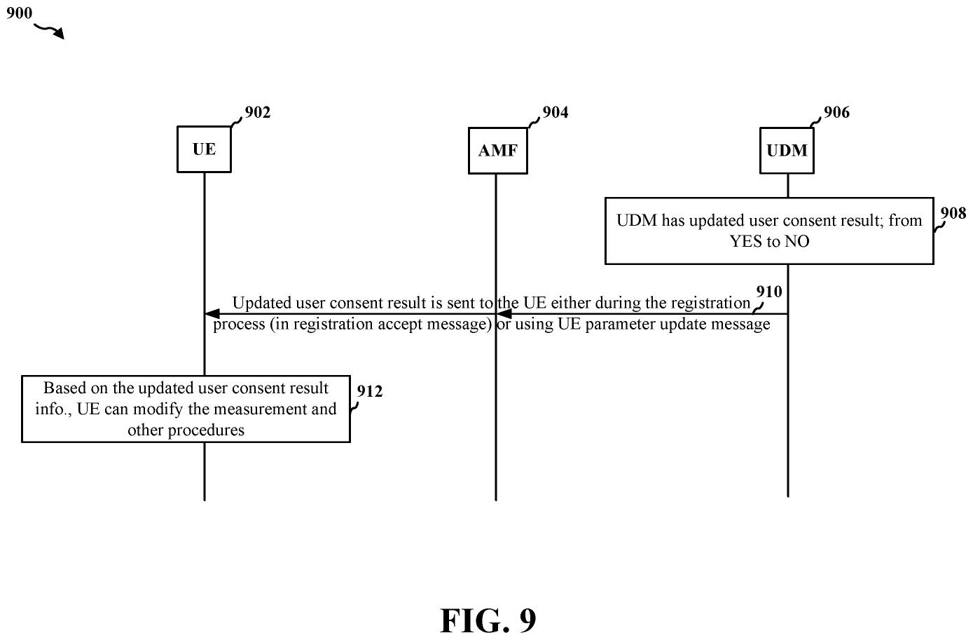

FIG. 9 is a diagram illustrating a communication flow 900 of an example method for enforcing an updated user consent result according to one or more aspects. In particular, at 908, the UDM 906 has identified that the user consent result has changed to being negative based on the latest inputs (e.g., 720, 722, 724) indicating the updated conditions or factors that may affect the user consent result.

At 910, the UDM 906 may transmit, to the UE 902, the updated user consent result. In one configuration, the UDM 906 may transmit the updated user consent result to the UE 902 during a registration process (e.g., via a registration accept message). In another configuration, the UDM 906 may transmit the updated user consent result to the UE 902 via a UE parameter update message. In some examples, the message carrying the updated user consent result from the UDM 906 may be forwarded by the AMF 904 before reaching the UE 902.

At 912, in some configurations, the UE 902 may modify the measurement (e.g., modify the measurement objects in the report) or other procedures associated with the data collection or processing task based on the updated user consent result information received from the UDM 906.

Accordingly, based on the process illustrated in FIG. 9, trace session modification (e.g., termination and reinitialization) upon a user consent result update may be avoided. Therefore, any unnecessary signaling may also be avoided.

If the UE 902 is to terminate the measurement and reporting (e.g., associated with the data collection or processing task) for an active (ongoing) trace session based on the updated user consent result, for the managing-based measurement and reporting, the UE 902 may indicate the termination of the trace session to the base station via a UE assistance information (UAI) message. For the signaling-based measurement and reporting, the UE 902 may indicate the termination of the trace session to the network using NAS signaling.

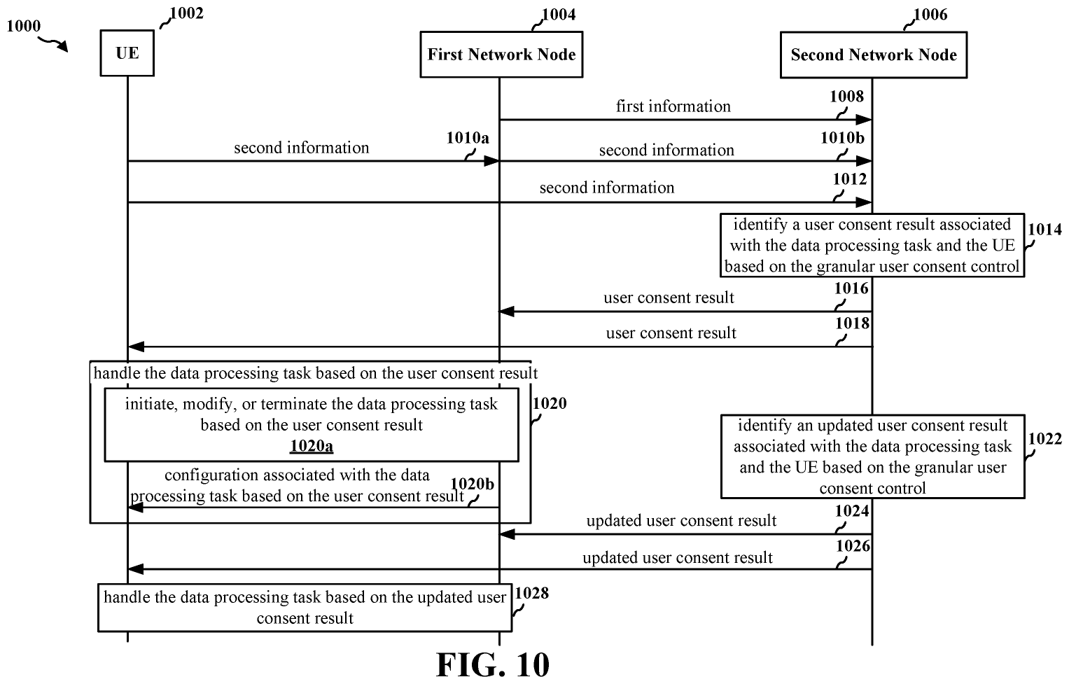

FIG. 10 is a diagram illustrating a communication flow 1000 of an example method of wireless communication. At 1008, the first network node 1004 (e.g., a subscribing entity) may transmit, to a second network node 1006 (e.g., a UDM), first information associated with granular user consent control. The first information may be further associated with a data processing task and a UE 1002. In one configuration, the transmission of the first information 1008 to the second network node 1006 may correspond to a request for a user consent result.

The first network node 1004 may receive, at 1010a, second information from the UE 1002, and may forward, at 1010b, the second information from the UE 1002 to the second network node 1006. The second information may be further associated with the data processing task and the UE 1002.

In addition, or in the alternative, at 1012, the second network node 1006 may receive, from the UE 1002, the second information associated with the granular user consent control.

At 1014, the second network node 1006 may identify a user consent result associated with the data processing task and a user of the UE 1002 based on the granular user consent control. The user consent result may be further based on the first information and/or the second information.

At 1016, the second network node 1006 may transmit, to the first network node 1004, and the first network node 1004 may receive, from the second network node 1006, the user consent result associated with the data processing task and the user of the UE 1002 based on the granular user consent control.

In addition, or in the alternative, at 1018, the second network node 1006 may transmit, to the UE 1002, the user consent result.

At 1020, the first network node 1004 may handle the data processing task based on the user consent result. At 1020a, the first network node 1004 may initiate, modify, or terminate the data processing task based on the user consent result 1016. At 1020b, the first network node 1004 may transmit, to the UE 1002, a configuration associated with the data processing task based on the user consent result 1016/1018.

In one configuration, the granular user consent control may be based on at least one of an area, a PLMN, a RAT, an RNC, a target area, a slice, a service associated with the data processing task, a carrier frequency, a time, a UE power status, available UE computational power, or the user of the UE. In one configuration, the user consent result may be further based on second information from the UE or the first information. The first information 1008 may indicate at least one of an area, a PLMN, a RAT, an RNC, a target area, or a carrier frequency. The second information 1010a/1010b/1012 may include a UE 1002 power status or an indication of available UE 1002 computational power.

In one configuration, the data processing task may be a data collection task based on a service associated with a service ID. In one configuration, the first network node 1004 may be a subscribing entity associated with the data processing task, and may be a data collection requesting entity associated with the data processing task or a data processor associated with the data processing task. In one configuration, the first network node 1004 may correspond to at least one of an OAM, a RAN, or an NWDAF. The second network node 1006 may correspond to a UDM. In one configuration, the second network node 1006 may store data associated with the granular user consent control.

At 1022, the second network node 1006 may identify an updated user consent result associated with the data processing task and the user of the UE 1002 based on the granular user consent control. The updated user consent result may be further based on updated first information or updated second information.

At 1024, the second network node 1006 may transmit, to the first network node 1004, and the first network node 1004 may receive, from the second network node 1006, an updated user consent result associated with the data processing task and the user of the UE 1002 based on the granular user consent control.

In addition, or in the alternative, at 1026, the second network node 1006 may transmit, to the UE 1002, the updated user consent result. In one configuration, the updated user consent result 1026 may be transmitted to the UE 1002 without a trace session modification. In one configuration, the user consent result 1026 may be transmitted to the UE 1002 via at least one third network node. In one configuration, the at least one third network node may correspond to an AMF or a base station.

At 1028, the first network node 1004 may handle the data processing task based on the updated user consent result 1024.

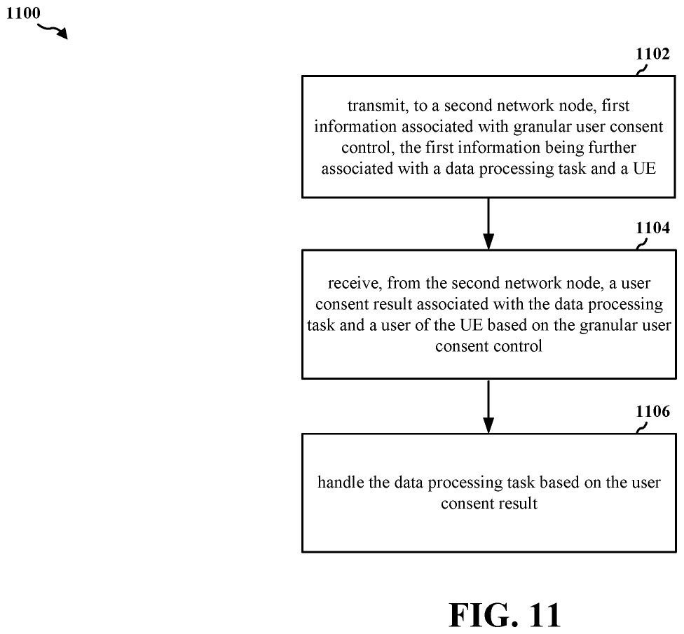

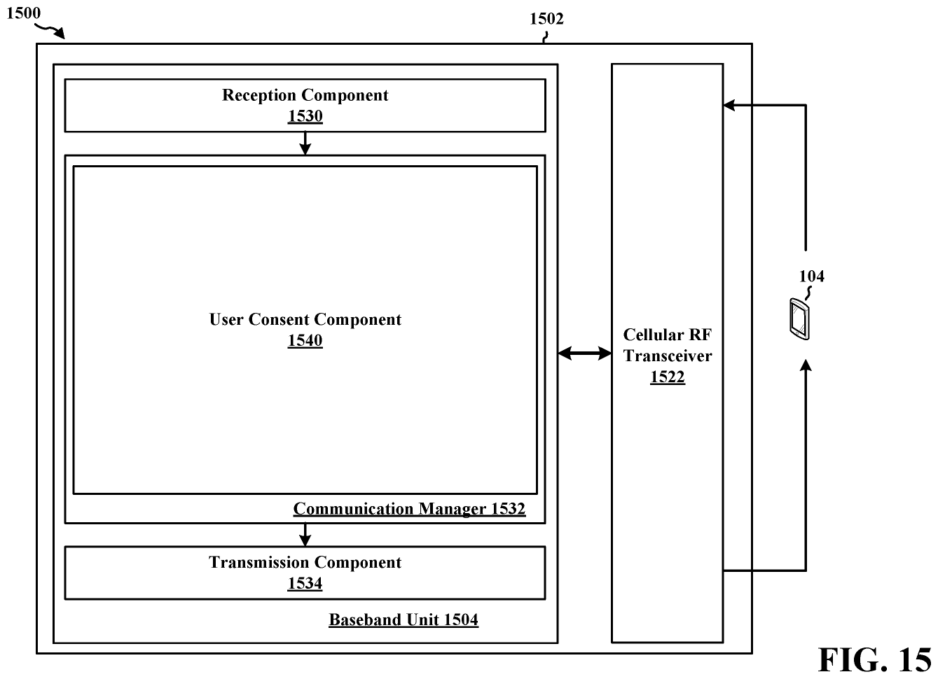

FIG. 11 is a flowchart 1100 of a method of wireless communication. The method may be performed by a first network node (e.g., the first network node 191; the subscribing entity 704; the first network node 1004; the apparatus 1502). At 1102, the first network node may transmit, to a second network node, first information associated with granular user consent control. The first information may be further associated with a data processing task and a UE. For example, 1102 may be performed by the user consent component 1540 in FIG. 15. Referring to FIG. 10, at 1008, the first network node 1004 may transmit, to a second network node 1006, first information associated with granular user consent control.

At 1104, the first network node may receive, from the second network node, a user consent result associated with the data processing task and a user of the UE based on the granular user consent control. For example, 1104 may be performed by the user consent component 1540 in FIG. 15. Referring to FIG. 10, at 1016, the first network node 1004 may receive, from the second network node 1006, a user consent result associated with the data processing task and a user of the UE 1002 based on the granular user consent control.

At 1106, the first network node may handle the data processing task based on the user consent result. For example, 1106 may be performed by the user consent component 1540 in FIG. 15. Referring to FIG. 10, at 1020, the first network node 1004 may handle the data processing task based on the user consent result.

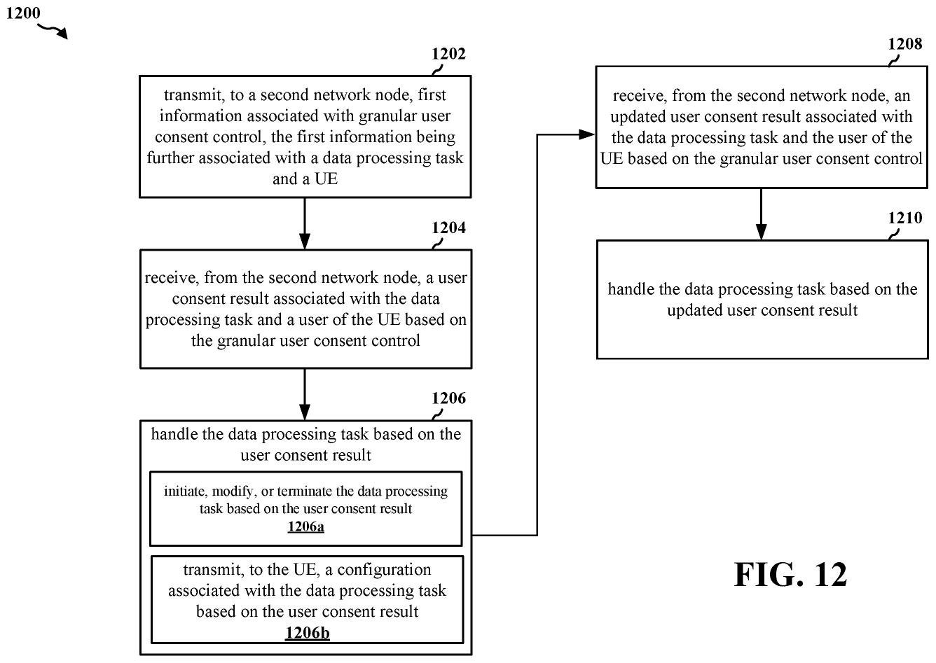

FIG. 12 is a flowchart 1200 of a method of wireless communication. The method may be performed by a first network node (e.g., the first network node 191; the subscribing entity 704; the first network node 1004; the apparatus 1502). At 1202, the first network node may transmit, to a second network node, first information associated with granular user consent control. The first information may be further associated with a data processing task and a UE. For example, 1202 may be performed by the user consent component 1540 in FIG. 15. Referring to FIG. 10, at 1008, the first network node 1004 may transmit, to a second network node 1006, first information associated with granular user consent control.

At 1204, the first network node may receive, from the second network node, a user consent result associated with the data processing task and a user of the UE based on the granular user consent control. For example, 1204 may be performed by the user consent component 1540 in FIG. 15. Referring to FIG. 10, at 1016, the first network node 1004 may receive, from the second network node 1006, a user consent result associated with the data processing task and a user of the UE 1002 based on the granular user consent control.

At 1206, the first network node may handle the data processing task based on the user consent result. For example, 1206 may be performed by the user consent component 1540 in FIG. 15. Referring to FIG. 10, at 1020, the first network node 1004 may handle the data processing task based on the user consent result.

In one configuration, the granular user consent control may be based on at least one of an area, a PLMN, a RAT, an RNC, a target area, a slice, a service associated with the data processing task, a carrier frequency, a time, a UE power status, available UE computational power, or the user of the UE.

In one configuration, referring to FIG. 10, the user consent result may be further based on second information from the UE or the first information. The first information 1008 may indicate at least one of an area, a PLMN, a RAT, an RNC, a target area, or a carrier frequency. The second information 1010a/1010b/1012 may include a UE power status or an indication of available UE computational power.

In one configuration, to handle the data processing task based on the user consent result, at 1206a, the first network node may initiate, modify, or terminate the data processing task based on the user consent result. For example, 1206a may be performed by the user consent component 1540 in FIG. 15. Referring to FIG. 10, at 1020a, the first network node 1004 may initiate, modify, or terminate the data processing task based on the user consent result 1016.

In one configuration, to handle the data processing task based on the user consent result, at 1206b, the first network node may transmit, to the UE, a configuration associated with the data processing task based on the user consent result. For example, 1206b may be performed by the user consent component 1540 in FIG. 15. Referring to FIG. 10, at 1020b, the first network node 1004 may transmit, to the UE 1002, a configuration associated with the data processing task based on the user consent result 1016/1018.

In one configuration, the data processing task may be a data collection task based on a service associated with a service ID.

In one configuration, referring to FIG. 10, the first network node 1004 may be a subscribing entity associated with the data processing task, and the subscribing entity may be a data collection requesting entity associated with the data processing task or a data processor associated with the data processing task.

In one configuration, referring to FIG. 10, the first network node 1004 may correspond to at least one of an OAM, a RAN, or an NWDAF. The second network node 1006 may correspond to a UDM.

In one configuration, at 1208, the first network node may receive, from the second network node, an updated user consent result associated with the data processing task and the user of the UE based on the granular user consent control. For example, 1208 may be performed by the user consent component 1540 in FIG. 15. Referring to FIG. 10, at 1024, the first network node 1004 may receive, from the second network node 1006, an updated user consent result associated with the data processing task and the user of the UE based on the granular user consent control.

At 1210, the first network node may handle the data processing task based on the updated user consent result. For example, 1210 may be performed by the user consent component 1540 in FIG. 15. Referring to FIG. 10, at 1028, the first network node 1004 may handle the data processing task based on the updated user consent result 1024.

In one configuration, referring to FIG. 10, the transmission of the first information 1008 to the second network node 1006 may correspond to a request for the user consent result.

In one configuration, referring to FIG. 10, the first network node 1004 may receive the second information 1010a from the UE 1002 and may forward 1010b the second information from the UE 1002 to the second network node 1006.

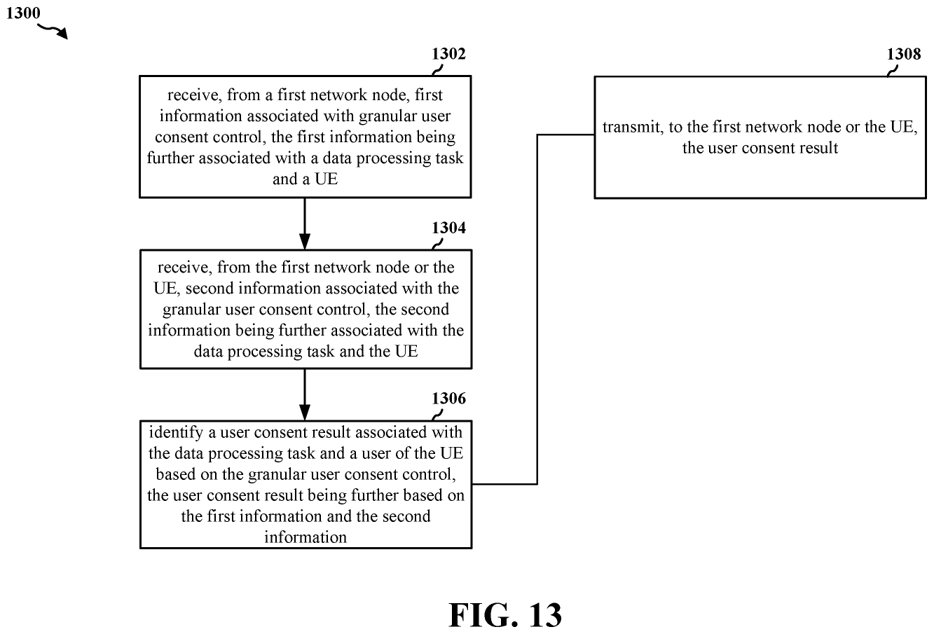

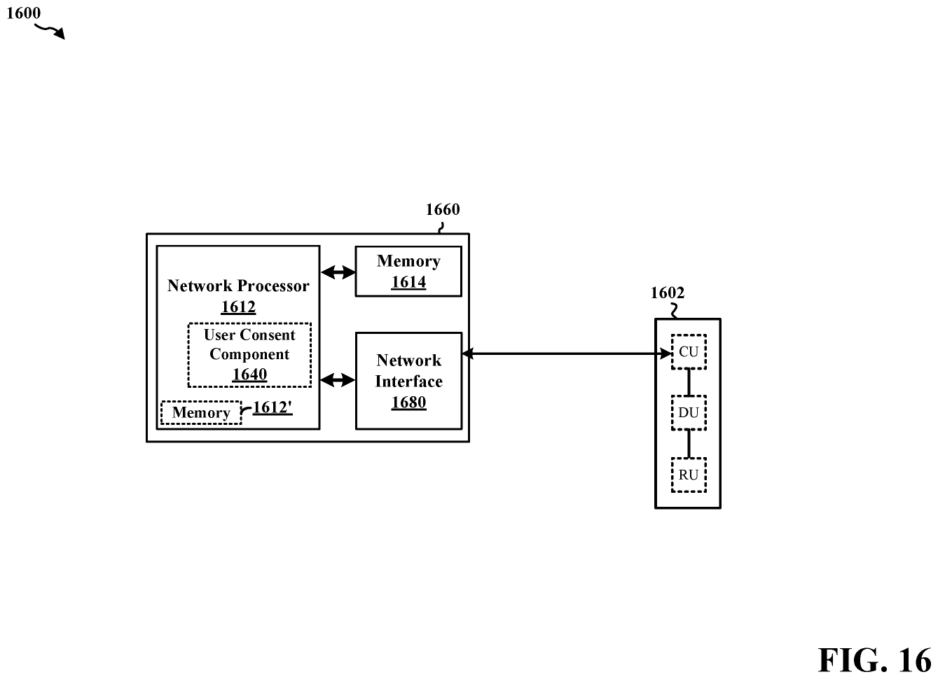

FIG. 13 is a flowchart 1300 of a method of wireless communication. The method may be performed by a second network node (e.g., the second network node 191′; the UDM 196/706/808/906; the second network node 1006; the apparatus 1660). At 1302, the second network node may receive, from a first network node, first information associated with granular user consent control. The first information may be further associated with a data processing task and a UE. For example, 1302 may be performed by the user consent component 1640 in FIG. 16. Referring to FIG. 10, at 1008, the second network node 1006 may receive, from a first network node 1004, first information associated with granular user consent control.

At 1304, the second network node may receive, from the first network node or the UE, second information associated with the granular user consent control. The second information may be further associated with the data processing task and the UE. For example, 1304 may be performed by the user consent component 1640 in FIG. 16.

Referring to FIG. 10, at 1010b or 1012, the second network node 1006 may receive, from the first network node 1004 or the UE 1002, second information associated with the granular user consent control.

At 1306, the second network node may identify a user consent result associated with the data processing task and a user of the UE based on the granular user consent control. The user consent result may be further based on the first information or the second information. For example, 1306 may be performed by the user consent component 1640 in FIG. 16. Referring to FIG. 10, at 1014, the second network node 1006 may identify a user consent result associated with the data processing task and a user of the UE 1002 based on the granular user consent control.

At 1308, the second network node may transmit, to the first network node or the UE, the user consent result. For example, 1308 may be performed by the user consent component 1640 in FIG. 16. Referring to FIG. 10, at 1016 or 1018, the second network node 1006 may transmit, to the first network node 1004 or the UE 1002, the user consent result.

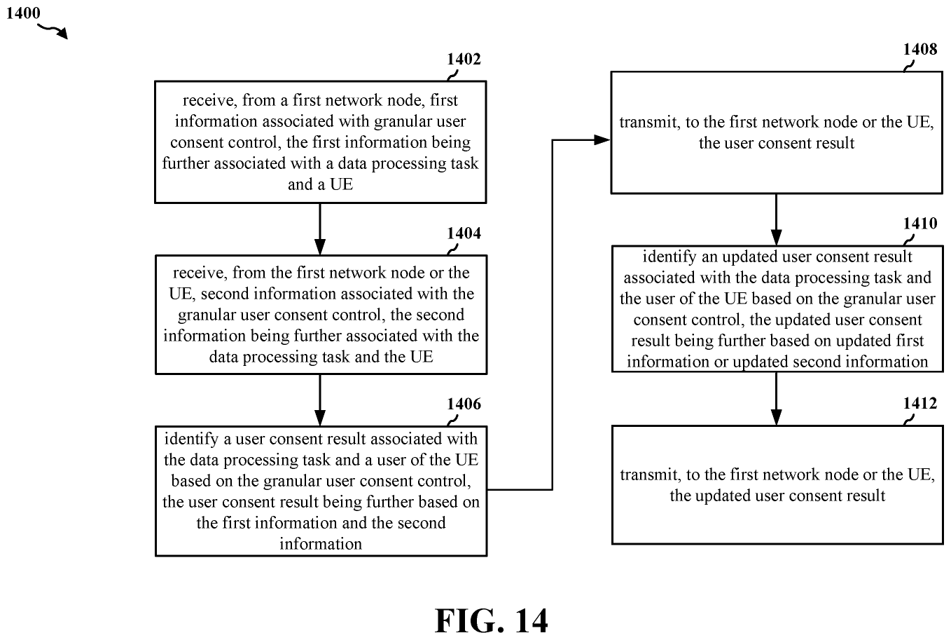

FIG. 14 is a flowchart 1400 of a method of wireless communication. The method may be performed by a second network node (e.g., the second network node 191′; the UDM 196/706/808/906; the second network node 1006; the apparatus 1660). At 1402, the second network node may receive, from a first network node, first information associated with granular user consent control. The first information may be further associated with a data processing task and a UE. For example, 1402 may be performed by the user consent component 1640 in FIG. 16. Referring to FIG. 10, at 1008, the second network node 1006 may receive, from a first network node 1004, first information associated with granular user consent control.

At 1404, the second network node may receive, from the first network node or the UE, second information associated with the granular user consent control. The second information may be further associated with the data processing task and the UE. For example, 1404 may be performed by the user consent component 1640 in FIG. 16. Referring to FIG. 10, at 1010b or 1012, the second network node 1006 may receive, from the first network node 1004 or the UE 1002, second information associated with the granular user consent control.

At 1406, the second network node may identify a user consent result associated with the data processing task and a user of the UE based on the granular user consent control. The user consent result may be further based on the first information or the second information. For example, 1406 may be performed by the user consent component 1640 in FIG. 16. Referring to FIG. 10, at 1014, the second network node 1006 may identify a user consent result associated with the data processing task and a user of the UE 1002 based on the granular user consent control.

At 1408, the second network node may transmit, to the first network node or the UE, the user consent result. For example, 1408 may be performed by the user consent component 1640 in FIG. 16. Referring to FIG. 10, at 1016 or 1018, the second network node 1006 may transmit, to the first network node 1004 or the UE 1002, the user consent result.

In one configuration, the granular user consent control may be based on at least one of an area, a PLMN, a RAT, an RNC, a target area, a slice, a service associated with the data processing task, a carrier frequency, a time, a UE power status, available UE computational power, or the user of the UE.

In one configuration, referring to FIG. 10, the first information 1008 may include at least one of an area, a PLMN, a RAT, an RNC, a target area, or a carrier frequency. The second information 1010a/1010b/1012 may include a UE power status or an indication of available UE computational power.

In one configuration, the data processing task may be a data collection task based on a service associated with a service ID.

In one configuration, referring to FIG. 10, the first network node 1004 may be a subscribing entity associated with the data processing task, and the subscribing entity may be a data collection requesting entity associated with the data processing task or a data processor associated with the data processing task.

In one configuration, referring to FIG. 10, the first network node 1004 may correspond to at least one of an OAM, a RAN, or an NWDAF. The second network node 1006 may correspond to a UDM.

In one configuration, at 1410, the second network node may identify an updated user consent result associated with the data processing task and the user of the UE based on the granular user consent control. For example, 1410 may be performed by the user consent component 1640 in FIG. 16. Referring to FIG. 10, at 1022, the second network node 1006 may identify an updated user consent result associated with the data processing task and the user of the UE 1002 based on the granular user consent control.

At 1412, the second network node may transmit, to the first network node or the UE, the updated user consent result. For example, 1412 may be performed by the user consent component 1640 in FIG. 16. Referring to FIG. 10, at 1024 or 1026, the second network node 1006 may transmit, to the first network node 1004 or the UE 1002, the updated user consent result.

In one configuration, referring to FIG. 10, the updated user consent result 1026 may be transmitted to the UE 1002 without a trace session modification.

In one configuration, referring to FIG. 10, the user consent result 1026 may be transmitted to the UE 1002 via at least one third network node.

In one configuration, the at least one third network node may correspond to an AMF or a base station.

In one configuration, referring to FIG. 10, the second network node 1006 may store data associated with the granular user consent control.

In one configuration, referring to FIG. 10, the first information 1008 received from the first network node 1004 may correspond to a request for the user consent result. The user consent result 1016 may be transmitted to the first network node 1004 based on the request for the user consent result.

FIG. 15 is a diagram 1500 illustrating an example of a hardware implementation for an apparatus 1502. The apparatus 1502 may be a first network node, a component of a first network node, or may implement first network node functionality. In some aspects, the apparatus 1502 may include a baseband unit 1504. The baseband unit 1504 may communicate through a cellular RF transceiver 1522 with the UE 104. The baseband unit 1504 may include a computer-readable medium/memory. The baseband unit 1504 is responsible for general processing, including the execution of software stored on the computer-readable medium/memory. The software, when executed by the baseband unit 1504, causes the baseband unit 1504 to perform the various functions described supra. The computer-readable medium/memory may also be used for storing data that is manipulated by the baseband unit 1504 when executing software. The baseband unit 1504 further includes a reception component 1530, a communication manager 1532, and a transmission component 1534. The communication manager 1532 includes the one or more illustrated components. The components within the communication manager 1532 may be stored in the computer-readable medium/memory and/or configured as hardware within the baseband unit 1504.

The communication manager 1532 includes a user consent component 1540 that may be configured to transmit, to a second network node, first information associated with granular user consent control, e.g., as described in connection with 1102 in FIGS. 11 and 1202 in FIG. 12. The user consent component 1540 may be configured to receive, from the second network node, a user consent result associated with the data processing task and a user of the UE based on the granular user consent control, e.g., as described in connection with 1104 in FIGS. 11 and 1204 in FIG. 12. The user consent component 1540 may be configured to handle the data processing task based on the user consent result, e.g., as described in connection with 1106 in FIGS. 11 and 1206 in FIG. 12. The user consent component 1540 may be configured to initiate, modify, or terminate the data processing task based on the user consent result, e.g., as described in connection with 1206a in FIG. 12. The user consent component 1540 may be configured to transmit, to the UE, a configuration associated with the data processing task based on the user consent result, e.g., as described in connection with 1206b in FIG. 12. The user consent component 1540 may be configured to receive, from the second network node, an updated user consent result associated with the data processing task and the user of the UE based on the granular user consent control, e.g., as described in connection with 1208 in FIG. 12. The user consent component 1540 may be configured to handle the data processing task based on the updated user consent result, e.g., as described in connection with 1210 in FIG. 12.

The apparatus may include additional components that perform each of the blocks of the algorithm in the flowcharts of FIGS. 5, 7, and 10-12. As such, each block in the flowcharts of FIGS. 5, 7, and 10-12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1502 may include a variety of components configured for various functions. In one configuration, the apparatus 1502, and in particular the baseband unit 1504, includes means for transmitting, to a second network node, first information associated with granular user consent control. The first information may be further associated with a data processing task and a UE. The apparatus 1502, and in particular the baseband unit 1504, includes means for receiving, from the second network node, a user consent result associated with the data processing task and a user of the UE based on the granular user consent control. The apparatus 1502, and in particular the baseband unit 1504, includes means for handling the data processing task based on the user consent result.

In one configuration, the granular user consent control may be based on at least one of an area, a PLMN, a RAT, an RNC, a target area, a slice, a service associated with the data processing task, a carrier frequency, a time, a UE power status, available UE computational power, or the user of the UE. In one configuration, the user consent result may be further based on second information from the UE or the first information. The first information may indicate at least one of an area, a PLMN, a RAT, an RNC, a target area, or a carrier frequency. The second information may include a UE power status or an indication of available UE computational power. In one configuration, to handle the data processing task based on the user consent result, the apparatus 1502, and in particular the baseband unit 1504, includes means for initiating, modifying, or terminating the data processing task based on the user consent result. In one configuration, to handle the data processing task based on the user consent result, the apparatus 1502, and in particular the baseband unit 1504, includes means for transmitting, to the UE, a configuration associated with the data processing task based on the user consent result. In one configuration, the data processing task may be a data collection task based on a service associated with a service ID. In one configuration, the first network node may be a data collection requesting entity associated with the data processing task or a data processor associated with the data processing task. In one configuration, the first network node may correspond to at least one of an OAM, a RAN, or an NWDAF. The second network node may correspond to a UDM. In one configuration, the apparatus 1502, and in particular the baseband unit 1504, includes means for receiving, from the second network node, an updated user consent result associated with the data processing task and the user of the UE based on the granular user consent control. The apparatus 1502, and in particular the baseband unit 1504, includes means for handling the data processing task based on the updated user consent result. In one configuration, the transmission of the first information to the second network node may correspond to a request for the user consent result. In one configuration, the first network node may receive second information from the UE and may forward the second information from the UE to the second network node.

The means may be one or more of the components of the apparatus 1502 configured to perform the functions recited by the means.

FIG. 16 is a diagram 1600 illustrating an example of a hardware implementation for a network entity 1660. In one example, the network entity 1660 may be within the core network 120. The network entity 1660 may include a network processor 1612. The network processor 1612 may include on-chip memory 1612′. In some aspects, the network entity 1660 may further include additional memory modules 1614. The network entity 1660 communicates via the network interface 1680 directly (e.g., backhaul link) or indirectly (e.g., through a MC) with the CU 1602. The on-chip memory 1612′ and the additional memory modules 1614 may each be considered a computer-readable medium/memory. Each computer-readable medium/memory may be non-transitory. The processor 1612 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 1640 may be configured to receive, from a first network node, first information associated with granular user consent control. The first information may be further associated with a data processing task and a UE. The component 1640 may be configured to receive, from the first network node or the UE, second information associated with the granular user consent control. The second information may be further associated with the data processing task and the UE. The component 1640 may be configured to identify a user consent result associated with the data processing task and a user of the UE based on the granular user consent control. The user consent result may be further based on the first information or the second information. The component 1640 may be configured to transmit, to the first network node or the UE, the user consent result. The component 1640 may be within the processor 1612. The component 1640 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1660 may include a variety of components configured for various functions. In one configuration, the network entity 1660 may include means for receiving, from a first network node, first information associated with granular user consent control. The first information may be further associated with a data processing task and a UE. The network entity 1660 may include means for receiving, from the first network node or the UE, second information associated with the granular user consent control. The second information may be further associated with the data processing task and the UE. The network entity 1660 may include means for identifying a user consent result associated with the data processing task and a user of the UE based on the granular user consent control. The user consent result may be further based on the first information or the second information. The network entity 1660 may include means for transmitting, to the first network node or the UE, the user consent result.

In one configuration, the granular user consent control may be based on at least one of an area, a PLMN, a RAT, an RNC, a target area, a slice, a service associated with the data processing task, a carrier frequency, a time, a UE power status, available UE computational power, or the user of the UE. In one configuration, the first information may include at least one of an area, a PLMN, a RAT, an RNC, a target area, or a carrier frequency. The second information may include a UE power status or an indication of available UE computational power. In one configuration, the data processing task may be a data collection task based on a service associated with a service ID. In one configuration, the first network node may be a data collection requesting entity associated with the data processing task or a data processor associated with the data processing task. In one configuration, the first network node may correspond to at least one of an OAM, a RAN, or an NWDAF. The second network node may correspond to a UDM. In one configuration, the network entity 1660 may include means for identifying an updated user consent result associated with the data processing task and the user of the UE based on the granular user consent control. The network entity 1660 may include means for transmitting, to the first network node or the UE, the updated user consent result. In one configuration, the updated user consent result may be transmitted to the UE without a trace session modification. In one configuration, the user consent result may be transmitted to the UE via at least one third network node. In one configuration, the at least one third network node may correspond to an AMF or a base station. In one configuration, the second network node may store data associated with the granular user consent control. In one configuration, the first information received from the first network node may correspond to a request for the user consent result. The user consent result may be transmitted to the first network node based on the request for the user consent result.

The means may be the component 1640 of the network entity 1660 configured to perform the functions recited by the means.

Referring back to FIGS. 4-16, a first network node may transmit, to a second network node, and the second network node may receive, from the first network node, first information associated with granular user consent control. The first information may be further associated with a data processing task and a UE. The second network node may receive, from the first network node or the UE, second information associated with the granular user consent control. The second information may be further associated with the data processing task and the UE. The second network node may identify a user consent result associated with the data processing task and a user of the UE based on the granular user consent control for the user for a specific service or services. The user consent result may be further based on the first information or the second information. The second network node may transmit, to the first network node, and the first network node may receive, from the second network node, the user consent result. Thereafter, the first network node may handle the data processing task based on the user consent result. Accordingly, user consent-based restrictions on data collection or processing tasks may be implemented and enforced at fine granularities, which may afford the user more flexibility in controlling the data collection or processing tasks.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a first network node including at least one processor coupled to a memory and configured to transmit, to a second network node, first information associated with granular user consent control, the first information being further associated with a data processing task and a UE; receive, from the second network node, a user consent result associated with the data processing task and a user of the UE based on the granular user consent control; and handle the data processing task based on the user consent result.

Aspect 2 is the apparatus of aspect 1, where the granular user consent control is based on at least one of an area, a PLMN, a RAT, an RNC, a target area, a slice, a service associated with the data processing task, a carrier frequency, a time, a UE power status, available UE computational power, or the user of the UE.

Aspect 3 is the apparatus of any of aspects 1 and 2, where the user consent result is further based on second information from the UE or the first information, the first information indicates at least one of an area, a PLMN, a RAT, an RNC, a target area, or a carrier frequency, and the second information includes a UE power status or an indication of available UE computational power.

Aspect 4 is the apparatus of any of aspects 1 to 3, where to handle the data processing task based on the user consent result, the at least one processor is further configured to: initiate, modify, or terminate the data processing task based on the user consent result.

Aspect 5 is the apparatus of any of aspects 1 to 4, where to handle the data processing task based on the user consent result, the at least one processor is further configured to: transmit, to the UE, a configuration associated with the data processing task based on the user consent result.

Aspect 6 is the apparatus of any of aspects 1 to 5, where the data processing task is a data collection task based on a service associated with a service ID.

Aspect 7 is the apparatus of any of aspects 1 to 6, where the first network node is a data collection requesting entity associated with the data processing task or a data processor associated with the data processing task.

Aspect 8 is the apparatus of any of aspects 1 to 7, where the first network node corresponds to at least one of an OAM, a RAN, or an NWDAF, and the second network node corresponds to a UDM.

Aspect 9 is the apparatus of any of aspects 1 to 8, the at least one processor being further configured to: receive, from the second network node, an updated user consent result associated with the data processing task and the user of the UE based on the granular user consent control; and handle the data processing task based on the updated user consent result.

Aspect 10 is the apparatus of any of aspects 1 to 9, where the transmission of the first information to the second network node corresponds to a request for the user consent result.

Aspect 11 is the apparatus of any of aspects 1 to 10, where the first network node receives second information from the UE and forwards the second information from the UE to the second network node.

Aspect 12 is the apparatus of aspect any of aspects 1 to 11, further including a transceiver coupled to the at least one processor.

Aspect 13 is an apparatus for wireless communication at a second network node including at least one processor coupled to a memory and configured to receive, from a first network node, first information associated with granular user consent control, the first information being further associated with a data processing task and a UE; receive, from the first network node or the UE, second information associated with the granular user consent control, the second information being further associated with the data processing task and the UE; identify a user consent result associated with the data processing task and a user of the UE based on the granular user consent control, the user consent result being further based on the first information or the second information; and transmit, to the first network node or the UE, the user consent result.

Aspect 14 is the apparatus of aspect 13, where the granular user consent control is based on at least one of an area, a PLMN, a RAT, an RNC, a target area, a slice, a service associated with the data processing task, a carrier frequency, a time, a UE power status, available UE computational power, or the user of the UE.

Aspect 15 is the apparatus of any of aspects 13 and 14, where the first information includes at least one of an area, a PLMN, a RAT, an RNC, a target area, or a carrier frequency, and the second information includes a UE power status or an indication of available UE computational power.

Aspect 16 is the apparatus of any of aspects 13 to 15, where the data processing task is a data collection task based on a service associated with a service ID.

Aspect 17 is the apparatus of any of aspects 13 to 16, where the first network node is a data collection requesting entity associated with the data processing task or a data processor associated with the data processing task.

Aspect 18 is the apparatus of any of aspects 13 to 17, where the first network node corresponds to at least one of an OAM, a RAN, or an NWDAF, and the second network node corresponds to a UDM.

Aspect 19 is the apparatus of any of aspects 13 to 18, the at least one processor being further configured to: identify an updated user consent result associated with the data processing task and the user of the UE based on the granular user consent control; and transmit, to the first network node or the UE, the updated user consent result.

Aspect 20 is the apparatus of aspect 19, where the updated user consent result is transmitted to the UE without a trace session modification.

Aspect 21 is the apparatus of any of aspects 13 to 20, where the user consent result is transmitted to the UE via at least one third network node.

Aspect 22 is the apparatus of aspect 21, where the at least one third network node corresponds to an AMF or a base station.

Aspect 23 is the apparatus of any of aspects 13 to 22, where the second network node stores data associated with the granular user consent control.

Aspect 24 is the apparatus of any of aspects 13 to 23, where the first information received from the first network node corresponds to a request for the user consent result, and the user consent result is transmitted to the first network node based on the request for the user consent result.

Aspect 25 is the apparatus of any of aspects 13 to 24, further including a transceiver coupled to the at least one processor.

Aspect 26 is a method of wireless communication for implementing any of aspects 1 to 25.

Aspect 27 is an apparatus for wireless communication including means for implementing any of aspects 1 to 25.

Aspect 28 is a computer-readable medium storing computer executable code, where the code when executed by a processor causes the processor to implement any of aspects 1 to 25.

What is claimed is:

1. An apparatus for wireless communication at a first network node, comprising:
a memory; and
at least one processor coupled to the memory and configured to:
transmit, to a second network node, first information associated with granular user consent control, the first information being further associated with a data processing task and a user equipment (UE);
receive, from the second network node, a user consent result associated with the data processing task and a user of the UE based on the granular user consent control; and
handle the data processing task based on the user consent result.

2. The apparatus of claim 1, wherein the granular user consent control is based on at least one of an area, a public land mobile network (PLMN), a radio access technology (RAT), a radio network controller (RNC), a target area, a slice, a service associated with the data processing task, a carrier frequency, a time, a UE power status, available UE computational power, or the user of the UE.

3. The apparatus of claim 1, wherein the user consent result is further based on second information from the UE or the first information, the first information indicates at least one of an area, a public land mobile network (PLMN), a radio access technology (RAT), a radio network controller (RNC), a target area, or a carrier frequency, and the second information includes a UE power status or an indication of available UE computational power.

4. The apparatus of claim 1, wherein to handle the data processing task based on the user consent result, the at least one processor is further configured to:
initiate, modify, or terminate the data processing task based on the user consent result.

5. The apparatus of claim 1, wherein to handle the data processing task based on the user consent result, the at least one processor is further configured to:
transmit, to the UE, a configuration associated with the data processing task based on the user consent result.

6. The apparatus of claim 1, wherein the data processing task is a data collection task based on a service associated with a service identifier (ID).

7. The apparatus of claim 1, wherein the first network node is a data collection requesting entity associated with the data processing task or a data processor associated with the data processing task.

8. The apparatus of claim 1, wherein the first network node corresponds to at least one of an operations, administration, and maintenance (OAM), a radio access network (RAN), or a network data analytics function (NWDAF), and the second network node corresponds to a unified data management (UDM).

9. The apparatus of claim 1, the at least one processor being further configured to:
receive, from the second network node, an updated user consent result associated with the data processing task and the user of the UE based on the granular user consent control; and
handle the data processing task based on the updated user consent result.

10. The apparatus of claim 1, wherein the transmission of the first information to the second network node corresponds to a request for the user consent result.

11. The apparatus of claim 1, wherein the first network node receives second information from the UE and forwards the second information from the UE to the second network node.

12. The apparatus of claim 1, further comprising a transceiver coupled to the at least one processor.

13. A method of wireless communication at a first network node, comprising:
transmitting, to a second network node, first information associated with granular user consent control, the first information being further associated with a data processing task and a user equipment (UE);
receiving, from the second network node, a user consent result associated with the data processing task and a user of the UE based on the granular user consent control; and
handling the data processing task based on the user consent result.

14. The method of claim 13, wherein the granular user consent control is based on at least one of an area, a public land mobile network (PLMN), a radio access technology (RAT), a radio network controller (RNC), a target area, a slice, a service associated with the data processing task, a carrier frequency, a time, a UE power status, available UE computational power, or the user of the UE.

15. The method of claim 13, wherein the user consent result is further based on second information from the UE or the first information, the first information indicates at least one of an area, a public land mobile network (PLMN), a radio access technology (RAT), a radio network controller (RNC), a target area, or a carrier frequency, and the second information includes a UE power status or an indication of available UE computational power.

16. An apparatus for wireless communication at a second network node, comprising:
a memory; and
at least one processor coupled to the memory and configured to:
receive, from a first network node, first information associated with granular user consent control, the first information being further associated with a data processing task and a user equipment (UE);
receive, from the first network node or the UE, second information associated with the granular user consent control, the second information being further associated with the data processing task and the UE;
identify a user consent result associated with the data processing task and a user of the UE based on the granular user consent control, the user consent result being further based on the first information or the second information; and
transmit, to the first network node or the UE, the user consent result.

17. The apparatus of claim 16, wherein the granular user consent control is based on at least one of an area, a public land mobile network (PLMN), a radio access technology (RAT), a radio network controller (RNC), a target area, a slice, a service associated with the data processing task, a carrier frequency, a time, a UE power status, available UE computational power, or the user of the UE.

18. The apparatus of claim 16, wherein the first information indicates at least one of an area, a public land mobile network (PLMN), a radio access technology (RAT), a radio network controller (RNC), a target area, or a carrier frequency, and the second information includes a UE power status or an indication of available UE computational power.

19. The apparatus of claim 16, wherein the data processing task is a data collection task based on a service associated with a service identifier (ID).

20. The apparatus of claim 16, wherein the first network node is a data collection requesting entity associated with the data processing task or a data processor associated with the data processing task.

21. The apparatus of claim 16, wherein the first network node corresponds to at least one of an operations, administration, and maintenance (OAM), a radio access network (RAN), or a network data analytics function (NWDAF), and the second network node corresponds to a unified data management (UDM).

22. The apparatus of claim 16, the at least one processor being further configured to:
identify an updated user consent result associated with the data processing task and the user of the UE based on the granular user consent control, the updated user consent result being further based on updated first information or updated second information; and
transmit, to the first network node or the UE, the updated user consent result.

23. The apparatus of claim 22, wherein the updated user consent result is transmitted to the UE without a trace session modification.

24. The apparatus of claim 16, wherein the user consent result is transmitted to the UE via at least one third network node.

25. The apparatus of claim 24, wherein the at least one third network node corresponds to an access and mobility management function (AMF) or a base station.

26. The apparatus of claim 16, wherein the second network node stores data associated with the granular user consent control.

27. The apparatus of claim 16, wherein the first information received from the first network node corresponds to a request for the user consent result, and the user consent result is transmitted to the first network node based on the request for the user consent result.

28. The apparatus of claim 16, further comprising a transceiver coupled to the at least one processor.

29. A method of wireless communication at a second network node, comprising:
receiving, from a first network node, first information associated with granular user consent control, the first information being further associated with a data processing task and a user equipment (UE);
receiving, from the first network node or the UE, second information associated with the granular user consent control, the second information being further associated with the data processing task and the UE;
identifying a user consent result associated with the data processing task and a user of the UE based on the granular user consent control, the user consent result being further based on the first information or the second information; and
transmitting, to the first network node or the UE, the user consent result.

30. The method of claim 29, wherein the granular user consent control is based on at least one of an area, a public land mobile network (PLMN), a radio access technology (RAT), a radio network controller (RNC), a target area, a slice, a service associated with the data processing task, a carrier frequency, a time, a UE power status, available UE computational power, or the user of the UE.
